(19) United States
(12) Patent Application Publication
(10) Pub. No.: US 2017/0293015 A1
(43) Pub. Date: Oct. 12, 2017

(54) SYSTEM, METHOD, AND STORAGE MEDIUM

(71) Applicant: FUJITSU LIMITED, Kawasak-shi (JP)

(72) Inventors: RYUSUKE NISHIKAWA, Kawasaki (JP); Yui Noma, Kawasaki (JP); TAKASHI MIURA, Kawasaki (JP)

(73) Assignee: FUJITSU LIMITED, Kawasaki-shi, Kanagawa (JP)

(21) Appl. No.: 15/441,298

(22) Filed: Feb. 24, 2017

(30) Foreign Application Priority Data
Apr. 12, 2016 (JP) 2016-079283

(51) Int. Cl. G01S 5/06; G01S 5/02; H04W 4/02

(52) U.S. Cl. CPC G01S 5/06; H04W 4/025; G01S 5/0221

(57) ABSTRACT

A system includes: circuitry configured to obtain position information indicating positions of communication devices, the communication devices being fixed at respective installation positions, obtain time information including information on times of reception of a communication from a mobile terminal by the communication devices, calculate coordinates in a second coordinate system in which a projection surface is present using a variable, the position information, and the time information, the second coordinate system having higher dimensions than a first coordinate system indicating the position information and the time information, the variable being used for projection of the first coordinate system onto the projection surface that is defined in the second coordinate system and onto which projection may be performed without limitation in a time direction, and identify a position of the mobile terminal by converting the calculated coordinates in the second coordinate system into coordinates in the first coordinate system.

### CROSS-REFERENCE TO RELATED APPLICATION

This application is based upon and claims the benefit of priority of the prior Japanese Patent Application No. 2016-079283, filed on Apr. 12, 2016, the entire contents of which are incorporated herein by reference.

### FIELD

The embodiments discussed herein are related to a system, a method, and a storage medium.

### BACKGROUND

There is a system which measures the position of a mobile terminal based on radio communication in a data communication network. In addition, there is a multilateration system in which a plurality of receiving stations receive a radio wave transmitted by an aircraft, and the position of the aircraft is measured based on received information.

Description will be made by taking, as an example, a system in which a managing terminal measures the position of a mobile terminal (MT) based on time and position information of a plurality of fixed terminals (FTs), for example. First, the managing terminal measures position data (X_{(I)}, y_{(I)}, z_{(I)}) of the plurality of FTs that received a radio wave transmitted from the MT and time data (t_{(I)}) on reception times of the plurality of FTs. Here, supposing that the number of FTs is K, I is a value from 1 to K. Next, the managing terminal defines Equation 16, which is a loss function (cost function) J₁, with the position data of each FT set as known position data, and calculates a position (x, y, z) and a time t of the MT that minimize Equation 16.

$${J}_{1} ( t , x , y , z ) = {\sum }_{I = 1}^{K} {( c ( {t}_{( I )} - t ) - \sqrt{{( x - {x}_{( I )} )}^{2} + {( y - {y}_{( I )} )}^{2} + {( z - {z}_{( I )} )}^{2}} )}^{2} \qquad ( 16 )$$

Examples of the related art include Japanese Laid-open Patent Publication No. 2012-2820, Japanese Laid-open Patent Publication No. 2002-250624, Japanese National Publication of International Patent Application No. 2006-520168, Japanese National Publication of International Patent Application No. 08-512130, and Japanese National Publication of International Patent Application No. 2006-518886.

### SUMMARY

According to an aspect of the embodiments, a system includes: circuitry configured to: obtain a plurality of pieces of position information indicating positions of a plurality of communication devices, the plurality of communication devices being fixed at respective installation positions obtain a plurality of pieces of time information, the plurality of pieces of time information including information on times of reception of a communication from a mobile terminal by the respective communication devices, calculate coordinates in a second coordinate system in which a projection surface is present using a variable, the plurality of pieces of position information, and the plurality of pieces of time information, the second coordinate system having higher dimensions than a first coordinate system indicating the plurality of pieces of position information and the plurality of pieces of time information, the variable being used for projection of the first coordinate system onto the projection surface that is defined in the second coordinate system and onto which projection may be performed without limitation in a time direction, and identify position information indicating a position of the mobile terminal by converting the calculated coordinates in the second coordinate system into coordinates in the first coordinate system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of assistance in explaining an example of entire configuration of a system according to a first embodiment;

FIG. 2 is a diagram of assistance in explaining correspondence relation between a hypersurface and four-dimensional space-time;

FIG. 3 is a diagram of assistance in explaining relation between a hyperplane and a hypersurface;

FIG. 4 is a diagram illustrating an applicable region of inverse stereographic projection;

FIG. 5 is a functional block diagram illustrating a functional configuration of a position identifying device according to the first embodiment;

FIG. 6 is a flowchart illustrating a flow of processing; and

FIG. 7 illustrates an example of configuration of hardware.

### DESCRIPTION OF EMBODIMENTS

The above-described technology uses a nonlinear least squares method that performs an iterative solution method such as a steepest-descent method or Newton's method to solve a minimization problem for a cost function J₁. Hence, iterative calculation is repeated until an appropriately set initial value converges to a given convergence value. This involves a high calculation cost and a heavy processing load, and it takes a time to measure the position.

In one aspect, it is an object to provide an information processing device, a position identifying method, and a position identifying program that may shorten position measurement time.

Embodiments of an information processing device, a position identifying method, and a position identifying program disclosed in the present application will hereinafter be described in detail with reference to the drawings. It is to be noted that the present technology is not limited by the embodiments.

### First Embodiment

[Entire Configuration]

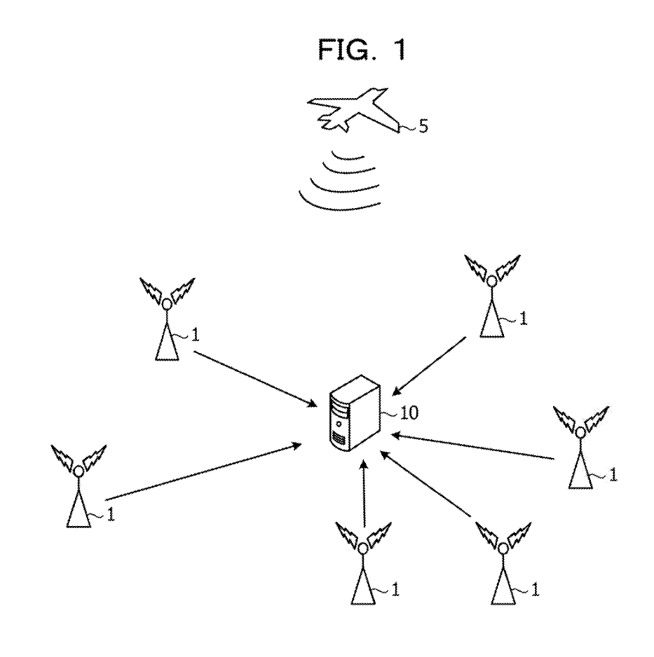

FIG. 1 is a diagram of assistance in explaining an example of entire configuration of a system according to a first embodiment. As illustrated in FIG. 1, this system is a multilateration system that includes a plurality of fixed terminals 1, a mobile terminal 5 such as an airplane, and a position identifying device 10, and which identifies the position of the mobile terminal 5.

The plurality of fixed terminals 1 are an example of receivers whose positions are fixed (the receivers will be referred to also as fixed terminals (FTs)). The plurality of fixed terminals 1 receive a radio wave from the mobile terminal 5. The plurality of fixed terminals 1 then transmit times, at which the radio wave is received from the mobile terminal 5 and position information of the plurality of fixed terminals 1 themselves to the position identifying device 10. Incidentally, suppose that the plurality of fixed terminals 1 are six terminals or more.

The mobile terminal 5 is an example of a moving transmitter (referred to also as a mobile terminal (MT)). The mobile terminal 5 transmits the radio wave at given, intervals of, for example, ten milliseconds or the like. Incidentally, an airplane, a mobile telephone, or the like is employed as an example of the mobile terminal 5.

The position identifying device 10 is an example of a server device that identifies the position of the mobile terminal 5. The position identifying device 10 identifies the position of the mobile terminal 5 using the times and the position information received from the respective fixed terminals 1, for example. In addition, the position identifying device 10 notifies the identified position of the mobile terminal 5 to an administrator, or displays the identified position of the mobile terminal 5 on a display unit such as a display.

In such a state, the position identifying device 10 performs an inverse stereographic projection from a four-dimensional Minkowski space-time (which may hereinafter be referred to simply as four-dimensional space-time) onto a hypersurface, redescribes a nonlinear equation in the four-dimensional space-time into a linear equation, and solves the linear equation.

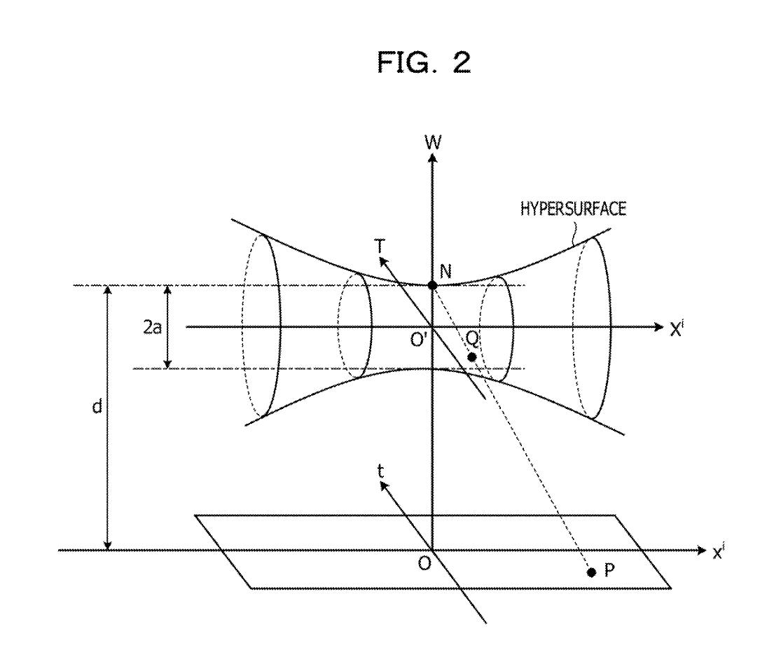

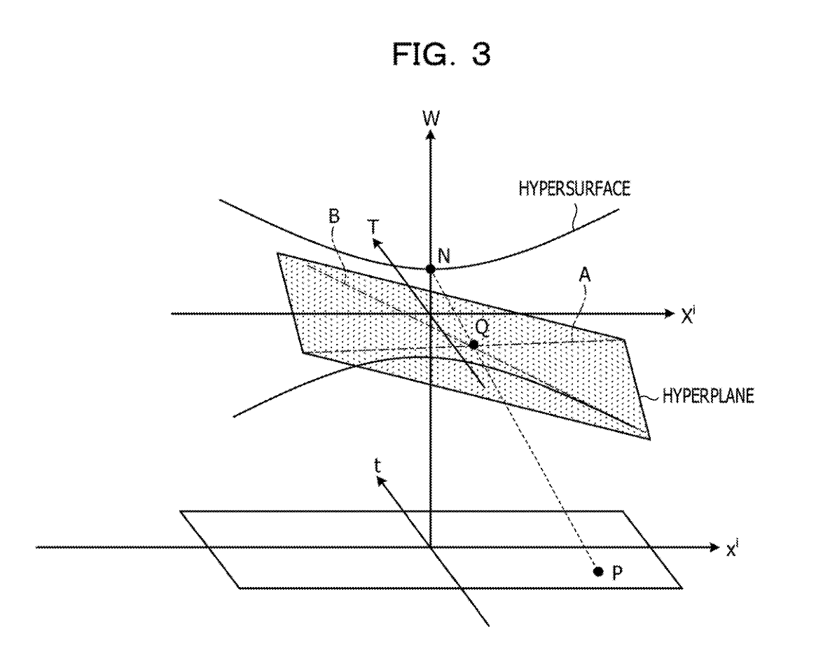

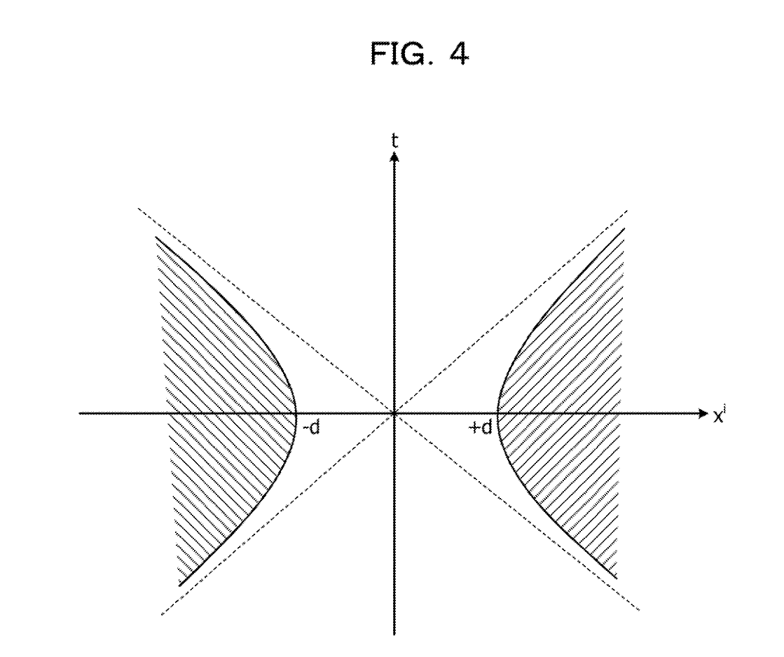

Here, an inverse stereographic projection onto a hypersurface twill be described with reference to FIGS. 2 to 4. FIG. 2 is a diagram of assistance in explaining correspondence relation between a hypersurface and four-dimensional space-time. FIG. 3 is a diagram of assistance in explaining relation between a hyperplane and a hypersurface. FIG. 4 is a diagram illustrating an applicable region of inverse stereographic projection. Incidentally, in the present embodiment, the position (x_{(I)}, y_{(I)}, z_{(I)}) and the time t_{(I)} of a fixed terminal 1, the position (x_{(I)}, y_{(I)}, z_{(I)} and the time t_{(I)} being known, are combined with each other, and the position (x, y, z) and the time t of the mobile terminal 5, the position (x, y, z) and the time t being unknown, are identified. “I” in the present embodiment is a label corresponding to the number of fixed terminals 1. For example, in a case where there are six fixed terminals 1, I is the value of 1, 2 3, 4, 5, or 6.

In order to perform the inverse stereographic projection, the position identifying device 10 sets a higher-dimensional space-time of five dimensions and a four-dimensional hypersurface, as illustrated in FIG. 2. Suppose that the coordinates of the higher-dimensional space-time of five dimensions are (T, X, Y, Z, W). Suppose that Xⁱ (i=1, 2, 3) in FIG. 2 represents (X¹, X², X³)=(X, Y, Z), and that xⁱ (i=1, 2, 3) represents (x¹, x², x³)=(x, y, z). In addition, suppose that the four-dimensional hypersurface is defined by Equation 1, and that the coordinates of the four-dimensional space-time are (t, x, y, z).

Here, suppose that a point N in the higher-dimensional space-time in FIG. 2 is a starting point of the inverse stereographic projection, and has a coordinate value (0, 0, 0, 0, a) in the higher-dimensional space-time. In addition, suppose that a distance between the point N and an origin O of the four-dimensional space-time is d. For example, the variable “d” is a distance from the origin O of the four-dimensional space-time to the point N. In addition, t and T are time axes. A point O is the origin in the four-dimensional space-time. A point O′ is an origin of the five-dimensional space-time in which the hypersurface is present. A point P is the position of the mobile terminal 5 in the four-dimensional space-time, for example, the position of a device to be identified. In addition, “a” is the radius of an aperture of the hypersurface, the aperture be ng around the origin of the five-dimensional space-time.

−W²−T²+X²+Y²+Z²=−a² (1)

Then, after setting the higher-dimensional space-time of five dimensions as in FIG. 2, the position identifying device 10 performs the inverse stereographic projection of the point P in the four-dimensional space-time onto a point Q in the higher-dimensional space-time, as illustrated in FIG. 2. Suppose that the point Q is a point of intersection of a straight line drawn from the point N to the point P and the hypersurface. The inverse stereographic projection from the point P onto the point Q is defined by f⁻¹ Equation 2. r² in Equation 2 is defined by Equation 3.

$$\begin{matrix}\begin{matrix}{f}^{- 1} ( t , x , y , z ) = ( \begin{matrix}- \frac{2 adt}{- {t}^{2} + {r}^{2} - {d}^{2}} , \frac{2 adx}{- {t}^{2} + {r}^{2} - {d}^{2}} , \\ \frac{2 ady}{- {t}^{2} + {r}^{2} - {d}^{2}} , \frac{2 adz}{- {t}^{2} + {r}^{2} - {d}^{2}} , a + \frac{2 {ad}^{2}}{- {t}^{2} + {r}^{2} - d}\end{matrix} \\ = ( T , X , Y , Z , W )\end{matrix} & ( 2 ) \\ {r}^{2} = {x}^{2} + {y}^{2} + {z}^{3} & ( 3 )\end{matrix}$$

The mobile terminal 5 as the MT and the plurality of fixed terminals 1 as the FTs are coupled to each other by radio wave communication. Therefore MT coordinates (t, x, y, z) and FT coordinates (t_{(I)}, x_{(I)}, y_{(I)}, z_{(I)}) in the four-dimensional space-time satisfy Equation 4. Then, Equation 5 is obtained by modifying Equation 4 using Equation 2. (T, Y, Z, W) in Equation 5 satisfy Equation 1. Incidentally, c in Equation 4 is the speed of light.

c(t_{I)}−t)−{square root over ((x−x_{(I)})²+(y−y_{(I)})²)}+(z−z_{(I)})²=0 (4)

−c²t_{(I)}T+x_{(I)}X+y_{(I)}Y+z_{(I)}Z+α_{(I)}W−β_{(I)}=0 (5)

Here, FIG. 3 is of assistance in explaining a geometrical meaning of Equation 5. A hyperplane in FIG. 3 is defined by Equation 5. A straight line A and a straight line B on the hyperplane represent lines of intersection of the hyperplane and the hypersurface. The straight line A and the straight line B are defined by Equation 1 and Equation 5. The conventional technology calculates the position of the MT by solving a minimization problem for the cost function J₁ in Equation 16 defined based on Equation 4. However, Equation 16 includes nonlinear terms with respect to the time and position coordinates of the MT, and thus involves a high calculation cost.

On the other hand, in the present embodiment, Equation 6 is defined based on Equation 5. The inside of parentheses on the right side of Equation 6 includes only linear terms with respect to the time and position coordinates of the MT in the higher dimensions. Therefore the calculation cost is reduced. Incidentally, “−c²t_{(I)}” in Equation 5 and Equation 6 is a multiplication of the speed of light c and the time t_{(I)} of the fixed terminal 1, “x_{(I)}, y_{(I)}, z_{(I)}” are the known position information of the fixed terminal 1. “T, X, Y, Z, W” are the coordinates of the higher-dimensional space-time of five dimensions. Incidentally, “α_{(I)}” and “β_{(I)}” are variables, and will be described later in detail.

$${J}_{2} ( T , X , Y , Z , W ) = {\sum }_{I = 1}^{K} {( - {c}^{2} {t}_{( I )} T + {x}_{( I )} X + {y}_{( I )} Y + {z}_{( I )} Z + {α}_{( I )} W - {β}_{( I )} )}^{2} \qquad ( 6 )$$

In addition, when defining Equation 6, the position identifying device 10 sets a variable d such that the positions of each of the fixed terminals 1 and the mobile terminal 5 in the four-dimensional space-time are included on the origin side of a hyperboloid in the four-dimensional space-time. For example, the position identifying device 10 sets an appropriate value as the variable d, the variable d being the distance from the origin O of the four-dimensional space-time to the point N illustrated in FIG. 2, so as to enable projection onto a projection surface onto which projection may be performed without limitation in a time direction, the projection surface being defined in a second coordinate system of higher dimensions than a first coordinate system indicating the positions and times of the plurality of fixed terminals 1.

For example, as illustrated in FIG. 4, the inverse stereographic projection is performed on each of the fixed terminals 1 and the mobile terminal 5 located in a region other than those of oblique lines, the region being on the origin side of a hyperboloid passing through ±d on the xⁱ axis. FIG. 4 indicates that the inverse stereographic projection is not limited in the time direction. Because of no limitation in the time direction, it is possible to deal with a case where there is a large error in the time of the MT.

[Functional Configuration]

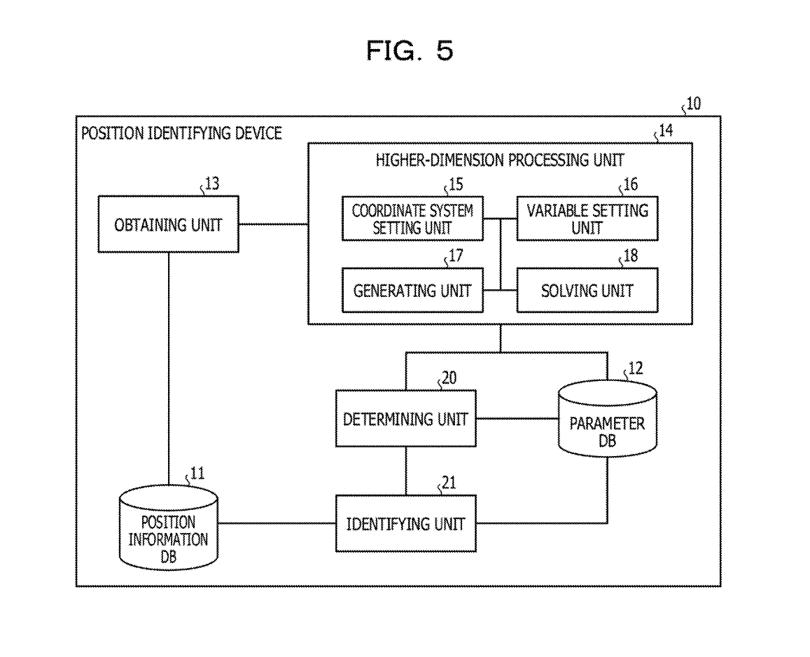

FIG. 5 is a functional block diagram illustrating a functional configuration of a position identifying device according to the first embodiment. The position identifying device depicted in FIG. 5 may be the position identifying device 10 depicted in FIG. 1. As illustrated in FIG. 5, the position identifying device 10 includes a position information database (DB) 11, a parameter DB 12, an obtaining unit 13, a higher-dimension processing unit 14, a determining unit 20 and an identifying unit 21.

Incidentally, the position information DB 11 and the parameter DB 12 are databases stored in a storage device such as a memory or a hard disk. The obtaining unit 13, the higher-dimension processing unit 14, the determining unit 20, and the identifying unit 21 are an example of an electronic circuit incorporated in a processor or an example of a process executed by the processor.

The position information DB 11 stores the position and time information of the identified mobile terminal 5, the position and time information of the fixed terminals 1, and the like. For example, the position information DB 11 stores the position and time information represented by coordinates in the four-dimensional space-time in which the mobile terminal 5 and the plurality of fixed terminals 1 are present. Incidentally, the coordinates are represented by x, y, z, and t, x, y, and z are information identifying a position, and t is time. In addition, the position information DB 11 stores the position and time information of the mobile terminal 5 measured by a processing unit to be described later.

The parameter DB 12 stores various kinds of parameters related to the inverse stereographic projection. For example, the parameter DB 12 stores various kinds of variables and the like calculated in intermediate calculations such as the inverse stereographic projection, coordinate calculation and coordinate transformation.

The obtaining unit 13 is a processing unit that obtains the position information and time information of the plurality of fixed terminals 1. The obtaining unit 13 then outputs the obtained pieces of information to the higher-dimension processing unit 14. Incidentally, the pieces of information obtained here are coordinates in the four-dimensional space-time. In addition, suppose that the here obtained position information of the fixed terminals 1 is (x_{(I)}, y_{(I)}, z_{(I)}, and that the here obtained time information of the fixed terminals 1 is (t_{(I)}).

The higher-dimension processing unit 14 is a processing unit that performs the above-described inverse stereographic projection, redescribes a nonlinear equation in the four-dimensional space-time into a linear equation, and solves the linear equation. The higher-dimension processing unit 14 includes a coordinate system setting unit 15, a variable setting unit 16, a generating unit 17, and a solving unit 18.

The coordinate system setting unit 15 is a processing unit that sets the origins of coordinates at a time of the inverse stereographic projection from the four-dimensional space-time onto the hypersurface. For example, the coordinate system setting unit 15 sets the origins of coordinates based on the information notified from the obtaining unit 13, and sets positional relation between the origin in the four-dimensional space-time and the origin in the five-dimensional space-time of coordinates. The coordinate system setting unit 15 then outputs information on the set origins and the time information and position information of the plurality of fixed terminals 1 which time information and position information are input from the obtaining unit 13 to each of the processing units within the higher-dimension processing unit 14.

As an example, the coordinate system setting unit 15 sets two axes xⁱ and Xⁱ in parallel with each other and sets two axes t and T in parallel with each other as positional relation between the origin O of the four-dimensional space-time and the origin O′ of the five-dimensional space-time in FIG. 2. In addition, as for the origin of time and the origin of space coordinates, the coordinate system setting unit 15 sets the time and position of a fixed terminal 1 nearest to the mobile terminal 5 as the origin.

For example, the coordinate system setting unit 15 obtains, from each of the fixed terminals 1, a time of reception of the radio wave. The coordinate system setting unit 15 then sets, as the origin, the position coordinates and the time coordinate of a fixed terminal 1 from which an earliest reception time is obtained,

For example, in a case where the position and time coordinates of a fixed terminal 1 having a smallest difference are (x_{(I)}, y_{(I)}, z_{(I)}), t_{(I)}), the coordinate system setting unit 15 sets x_{(I)}=y_{(I)}=Z_{(I)}=t_{(I)}=0. In addition, in a case where the position and time coordinates of another fixed terminal 1 are (x₍₂₎, y₍₂₎, z₍₂₎, t₍₂₎), the coordinate system setting unit 15 sets the position and time coordinates of this terminal as (x₍₂₎−x₍₁₎, y₍₂₎−y₍₁₎, z₍₂₎−z₍₁₎, t₍₂₎−t₍₁₎). Here, a geodetic system is, for example, a system configured to express a position on earth by coordinates using longitude and latitude as well as altitude, or a coordinate system serving as a reference in positioning or the like. There is WGS84 (WGS: world geodetic system) or the like as a typical geodetic system.

The variable setting unit 16 is a processing unit that makes an initial setting of the variable d, the variable d enabling generation of the linear equation (Equation (6)) and being such that the positions of the plurality of fixed terminals 1 and the mobile terminal 5 are included on the origin side of the hyperboloid in the four-dimensional space, at a time of performing the inverse stereographic projection of the plurality of fixed terminals 1 and the mobile terminal 5 onto the hypersurface. For example, in order to calculate the position and the time of the MT in the higher dimensions, the variable setting unit 16 sets a provisional variable d for the variable d. Incidentally, the provisional variable d will be described as “d_{b}.”

For example, in order to perform the inverse stereographic projection in the higher-dimensional space-time, the variable setting unit 16 sets the variable d satisfying Equation 7. Here, “I_{I}” in Equation 7 is a higher-dimension fixed variable, and is defined by Equation 8. Incidentally, “c” in Equation 8 is the speed of light. Under such conditions, the variable setting unit 16 sets “d_{b}”satisfying Equation 9 as an initial value. “d_{b}” initially set here satisfies Equation 7.

$$\begin{matrix}d > max \{ {l}_{I} , I = 1 , 2 , … , K \} & ( 7 ) \\ {l}_{( I )} = \sqrt{- {c}^{2} {t}_{( I )}^{2} + {x}_{( I )}^{2} + {y}_{( I )}^{2} + {z}_{( I )}^{2}} , I = 1 , … , K & ( 8 ) \\ {d}_{b} = 2 \times max \{ {l}_{I} , I = 1 , 2 , … , K \} & ( 9 )\end{matrix}$$

The generating unit 17 is a processing unit that generates Equation 6, which is a linear equation on the hypersurface. For example, the generating unit 17 generates Equation 6 using the origin information and the position information input from the coordinate system setting unit 15 and the variable d input from the variable setting unit 16. The generating unit 17 first gives “a” as a higher-dimension fixed variable by Equation 10.

$$a = \frac{max \{ {l}_{I} , I = 1 , … , K \} - min \{ {l}_{I} , I = 1 , … , K \}}{2} \qquad ( 10 )$$

Next, the generating unit 17 defines “α_{(I)}” and “β_{(I)}” as higher-dimension fixed variables by Equation 11. Here, “α_{(I)}” and “β_{(I)}” are calculated by substituting “I_{I}” given by Equation 8 and “d_{b}” given by Equation 9 into Equation 11.

$${α}_{( I )} = \frac{{l}_{( I )}^{2} + {d}^{2}}{2 d} , {β}_{( I )} = \frac{a ( {l}_{( I )}^{2} - {d}^{2} )}{2 d} \qquad ( 11 )$$

Using the thus calculated values, the solving unit 18 calculates the time and position coordinates of the MT (mobile terminal 5) in the higher dimensions by solving a minimization problem for the cost function J₂ defined by Equation 6. Incidentally, “−c²t_{(I)}” in Equation 6 is a known value obtained by multiplying together the speed of light c and the time t of the fixed terminal 1, “x_{(I)}, y_{(I)}, z_{(I)})” are known position information of the fixed terminal 1, and “α_{(I)}” and “β_{(I)}” are known values calculated using Equation 11. Incidentally, “T, X, Y, Z, W” are coordinates in the higher-dimensional space-time of five dimensions, and are unknown values to be calculated.

Here, the solving unit 18 gives the minimization problem for Equation 6 by Equation 12, and solves Equation 12 using a linear least squares method. Further, the solving unit 18 calculates “d” by solving a minimization problem for a cost function J₃ defined by Equation 13 using higher-dimensional position and time information of the mobile terminal 5, the higher-dimensional position and time information being obtained from Equation 12. At this time, the solving unit 18 gives the minimization problem for the cost function J₃ by Equation 14, and solves Equation 14 until Equation 14 converges to a given convergence value, using a nonlinear least squares method that performs an iterative solution method such as a steepest-descent method or Newton's method. This problem is guaranteed to converge to a minimum solution. The solving unit 18 then outputs the calculated “d” to the determining unit 20. Incidentally, in place of the iterative solution method, simulated annealing or the like may be adopted, and various methods for calculating an optimum solution may be adopted.

$$\begin{matrix} ( T , X , Y , Z , W ) = arg {min}_{\hat{T} , \hat{X} , \hat{Y} , \hat{Z} , \hat{W}} {J}_{2} ( \hat{T} , \hat{X} , \hat{Y} , \hat{Z} , \hat{W} ) & ( 12 ) \\ {J}_{3} ( d ) = {\sum }_{I = 1}^{K} {( - {c}^{2} {t}_{( I )} T + {x}_{( I )} X + {y}_{( I )} Y + {z}_{( I )} Z + {a}_{( I )} ( d ) W - {β}_{( I )} ( d ) )}^{2} & ( 13 ) \\ d = arg {min}_{\hat{d}} {J}_{3} ( \hat{d} ) & ( 14 )\end{matrix}$$

The determining unit 20 is a processing unit that determines the variable d. For example, the determining unit 20 compares “d” calculated by the solving unit 18 with “d_{b}” described above, and determines whether a difference between “d” and “d_{b}” falls within the range of a given convergence value E. Then, when the above-described difference is within the range of the convergence value E, the determining unit 20 determines “d” at that time as the variable, and instructs the identifying unit 21 to identify the position of the mobile terminal 5. When the above-described difference is not within the range of the convergence value E, on the other hand, the determining unit 20 requests the solving unit 18 to perform processing

For example, when an absolute value |d−d_{b}| of the difference between “d” calculated by the solving unit 18 and “d_{b}” is smaller than the convergence value E, the determining unit 20 determines “d” at this time as the variable. When the absolute value |d−d_{b}| is equal to or larger than the convergence value E, on the other hand, the determining unit 20 updates “d_{b}” as the provisional d by setting “d_{b}=d,” and notifies “d_{b}” after the update to the solving unit 18. Receiving this notification, the solving unit 18 updates “α_{(I)}” and “β_{(I)}” by substituting “d_{b}” after the update into Equation 11, solves the minimization problem for the cost function J₂ (Equation 6) and the minimization problem for the cost function J₃ (Equation 13), and calculates new “d.” Similar processing is then repeated.

The identifying unit 21 is a processing unit that identifies position information and time information of the mobile terminal 5. For example, the identifying unit 21 calculates the time and position coordinates of the mobile terminal 5 in the four-dimensional space-time, using the variable d determined by the determining unit 20 and a as a higher-dimension fixed variable.

For example, the identifying unit 21 obtains the above-described variable d from the determining unit 20, obtains the higher-dimension fixed variable a from the solving unit 18, and obtains the coordinates “T, X, Y, Z, W” in the higher-dimensional space-time of five dimensions from the solving unit 18. Then, the identifying unit 21 substitutes the obtained values into Equation 15, and calculates time information t and position information (x, y, z) in the four-dimensional space-time of the mobile terminal 5. Thereafter, the identifying unit 21 outputs the calculated time information t and the calculated position information (x, y, z) in the four-dimensional space-time of the mobile terminal 5 on a display, or stores the calculated time information t and, the calculated position information (x, y, z) in the position information DB 11.

$$t = \frac{d}{a - W} T \\ x = \frac{d}{a - W} X \\ y = \frac{d}{a - W} Y \\ z = \frac{d}{a - W} Z \qquad ( 15 )$$

In addition, the identifying unit 21 appropriately converts the calculated time information t and the calculated position information (x, y, z) in the four-dimensional space-time of the mobile terminal 5 according to the coordinate origin. For example, the calculated time information t and the calculated position information (x, y, z) in the four-dimensional space-time of the mobile terminal 5 in this case are values obtained by setting the fixed terminal 1 closest to the mobile terminal 5 as the origin. Therefore, the position of the mobile terminal 5 is accurately identified by converting the time information t and the position information (x, y, z) in the four-dimensional space-time of the mobile terminal 5 according to the coordinate origin. For example, the identifying unit 21 converts the time information t and the position information (x, y, z) in the four-dimensional space-time of the mobile terminal 5 into (t+t₍₁₎, x+x₍₁₎y+y₍₁₎, z+z₍₁₎), and outputs (t+t₍₁₎, x+x₍₁₎, y+y₍₁₎, z+z₍₁₎)) on the display or stores (t+t₍₁₎, x+x₍₁₎, y+y₍₁₎, z+z₍₁₎)) in the position information DB 11.

[Flow of Processing]

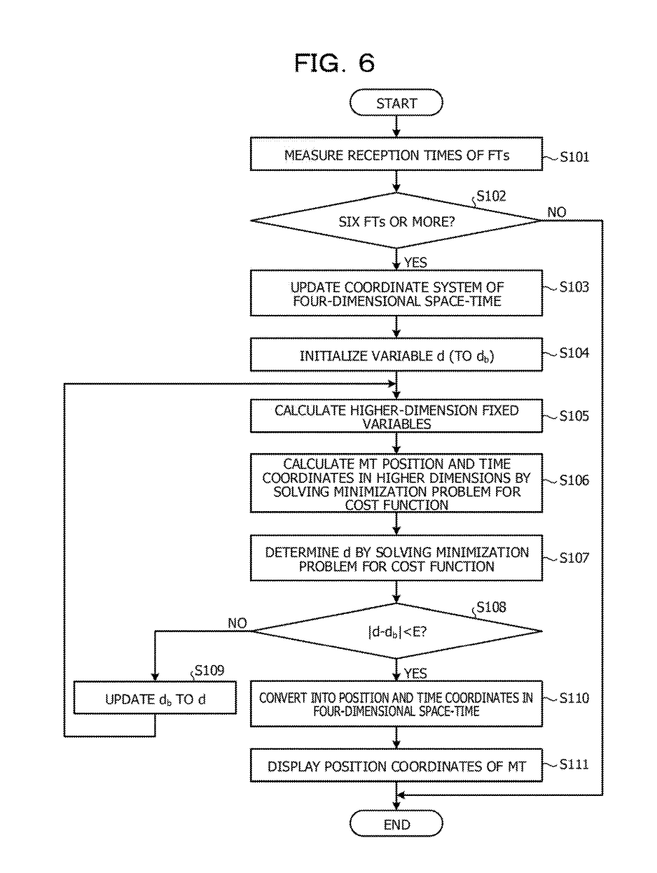

FIG. 6 is a flowchart illustrating a flow of processing. As illustrated in FIG. 6, the position identifying device 10 measures a reception time that is a time at which each fixed terminal (FT) 1 receives the radio wave from the mobile terminal (MT) 5 (S101). For example, the position identifying device 10 sets the position and time information of each fixed terminal 1 as (x′_{(I)}, y′_{(I)} z′_{(I)}, t′_{(I)}).

Next, when the position identifying device 10 has measured the reception times of six FTs or more (S102: Yes), the position identifying device 10 updates the coordinate system of the four-dimensional space-time (S103). For example, the position identifying device 10 updates the coordinate system of the four-dimensional space-time such that an FT at a position nearest to the mobile terminal 5 is at the origin. Here, the position identifying device 10 updates the position and time information (t′_{(I)}, x′_{(I)}, y′_{(I)}, z′_{(I)}) of each fixed terminal 1 to (t)_{(I)}, x_{(I)}, Y_{(I)}).

Then, the position identifying device 10 initializes the variable d to “d_{b}” (S104). Thereafter, the position identifying device 10 calculates higher-dimension fixed variables (S105). For example, the position identifying device 10 calculates the higher-dimension fixed variables I_{(I)}, a, α_{(I)}, and β_{(I)} using the position and time information (t_{(I)}, x_{(I)}, y_{(I)}, z_{(I)}) of each fixed terminal 1 and “d_{b}.”

Next, the position identifying device 10 calculates the position and time information of the mobile terminal 5 in the higher dimensions by solving the minimization problem for the cost function J₂ (S106). For example, the position identifying device 10 calculates the position and time information (T, X, Y, Z, W) of the mobile terminal 5 in the higher dimensions using the position and time information (t_{(I)}, x_{(I)}, y_{(I)}, z_{(I)}) of each fixed terminal 1 and the higher-dimension fixed variables I_{(I)}, a, α_{(I)}, and β_{(I)}.

Thereafter, the position identifying device 10 determines the variable d by solving the minimization problem for the cost function J₃ (S107). For example, the position identifying device 10 calculates the higher-dimension free variable d using the higher-dimension fixed variable a, the position and time information (t_{(I)}, x_{(I)}, y_{(I)}, z_{(I)}) of each fixed terminal 1, and the position and time information (T, X, Y, Z, W) of the mobile terminal 5 in the higher dimensions.

Next, when the calculated higher-dimension free variable d does not satisfy “|d−d_{b}<Convergence Value E” (S108: No), the position identifying device 10 updates d_{b} to d (S109), and repeats S105 and subsequent steps.

When the calculated higher-dimension free variable ,d satisfies “|d−d_{b}<Convergence Value E” (S108: Yes), on the other hand, the position identifying device 10 converts the position and time information of the mobile terminal 5 in the higher dimensions into position and time information in the four-dimensional space-time (S110). For example, the position identifying device 10 calculates the position and time information (t, x, y, z) of the mobile terminal 5 in the four-dimensional space-time using the higher-dimension fixed variable a, the higher-dimension free variable d, and the position and time information (T, X, Y, Z, W) of the mobile terminal 5 in the higher dimensions,

Thereafter, the position identifying device 10 extracts the position coordinates (x, y, z) of the MT from the calculated position and time information (t, x, y, z) of the mobile terminal 5 in the four-dimensional space-time, and displays the position coordinates (x, y, z) of the MT (S111). At this time, the position identifying device 10 may update the calculated position coordinates (x, y, z) such that the original origin is set as a reference, and thereafter display the updated position coordinates (x, y, z).

[Effect]

As described above, the position identifying device 10 uses a linear least squares method for the calculation of the time and position information (T, X, Y, Z, W) of the MT in the higher dimensions. This reduces the calculation cost as compared with the conventional method using an iterative solution method. Hence, the time for position measurement in the position identifying device 10 is shortened.

In addition, the position identifying device 10 defines the cost function J₃ anew based on the position and time information of the FTs and the position and time information of the MT in the five-dimensional space-time, and calculates the variable d that minimizes the cost function J₃. The variable d that minimizes an error due to error propagation is thereby estimated. Hence, the position identifying device 10 calculates the variable d that minimizes the error propagation. The position of the MT is therefore determined with high accuracy.

### Second Embodiment

An embodiment of the present technology has been described thus far. However, the present technology may be carried out in various different forms other than the embodiment described above.

[Cloud Environment]

In the foregoing embodiment, description has been made of an example in which the position identifying device 10 performs position identification. However, the present technology is not limited to this. For example, a server using cloud service may perform the above-described position identification processing.

[System]

In addition, the respective configurations of the illustrated devices do not necessarily need to be physically configured as illustrated in the figures. For example, the respective configurations of the illustrated devices may be configured so as to be distributed or integrated in arbitrary units. For example, the coordinate system setting unit 15 and the variable setting unit 16 may be integrated with each other, and the higher-dimension processing unit 14, the determining unit 20, and the identifying unit 21 may be integrated with each other. Further, the whole or an arbitrary part of the processing functions performed in the respective devices may be implemented by a central processing unit (CPU) and a program analyzed and executed in the CPU, or may be implemented as hardware based on wired logic,

In addition, among the pieces of processing described in the present embodiment, the whole or a part of the processing described as being performed automatically may be performed manually, or the whole or a part of the processing described as being performed manually may be performed automatically by a publicly known method. In addition, processing procedures, control procedures, specific names, and information including various kinds of data and parameters that are illustrated in the document and in the drawings may be changed arbitrarily unless otherwise specified.

[Hardware Configuration]

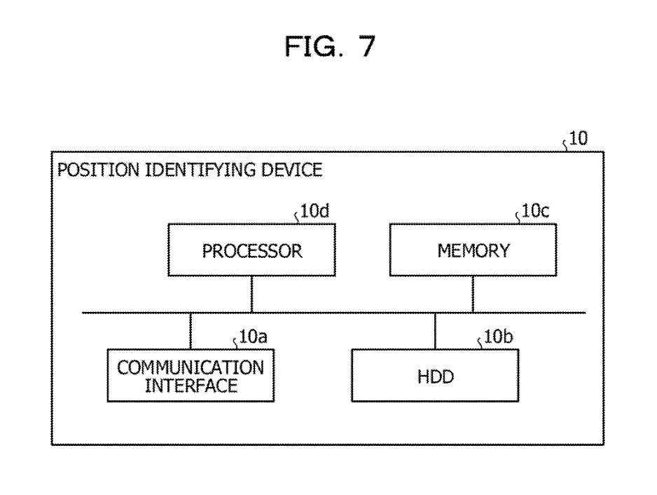

FIG. 7 illustrates an example of hardware configuration of a position identifying device. The position identifying device depicted in FIG. 7 may be the position identifying device 10 depicted in FIG. 1. As illustrated in FIG. 7, the position identifying device 10 includes a communication interface 10a, a hard disk drive (HDD) 10b, a memory 10c, and a processor 10d. Incidentally, the position identifying device 10 may include a display unit such as a display or a touch panel in addition to the constituent elements illustrated here, and may include other hardware.

An example of the communication interface 10a is a network interface card or the like. The HDD 10b is a storage device storing the various kinds of DBs illustrated in FIG. 5 and the like.

An example of the memory 10c is a random access memory (RAM) such as a synchronous dynamic random access memory (SDRAM), a read only memory (ROM), a flash memory, or the like. An example of the processor 10d is a CPU, a digital signal processor (DSP), a field programmable gate array (FPGA), a programmable logic device (PLD), or the like.

In addition, the position identifying device 10 operates as an information processing device that performs the position identifying method by reading and executing a program. For example, the position identifying device 10 executes a program that performs functions similar to those of the obtaining unit 13, the higher-dimension processing unit 14, the determining unit 20, and the identifying unit 21. Consequently, the position identifying device 10 may execute a process that performs functions similar to those of the obtaining unit 13, the higher-dimension processing unit 14, the determining unit 20, and the identifying unit 21. It is to be noted that the program referred to in this other embodiment is not limited to being executed by the position identifying device 10. For example, another computer or another server may execute the program, or the other computer and the other server may execute the program in cooperation with each other.

This program may be distributed via a network such as the Internet. In addition, this program is recorded on a computer-readable recording medium such as a hard disk, a flexible disk (FD), a compact disc read only memory (CD-ROM), a magneto-optical disk (MO) or a digital versatile disc (DVD), and is executed by being read from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
circuitry configured to:
obtain a plurality of pieces of position information indicating positions of a plurality of communication devices, the plurality of communication devices being fixed at respective installation positions,
obtain a plurality of pieces of time information, the plurality of pieces of time information including information on times of reception of a communication from a mobile terminal by the respective communication devices,
calculate coordinates in a second coordinate system in which a projection surface is present using a variable, the plurality of pieces of position information, and the plurality of pieces of time information, the second coordinate system having higher dimensions than a first coordinate system indicating the plurality of pieces of position information and the plurality of pieces of time information, the variable being used for projection of the first coordinate system onto the projection surface that is defined in the second coordinate system and onto which projection may be performed without limitation in a time direction, and
identify position information indicating a position of the mobile terminal by converting the calculated coordinates in the second coordinate system into coordinates in the first coordinate system,

2. The system according to claim 1, wherein the circuitry is configured to:
define a loss function using the plurality of pieces of position information, the plurality of pieces of time information, and the output coordinates of the mobile terminal in the second coordinate system
set the variable that minimizes the loss function, and
convert the coordinates in the second coordinate system into the coordinates in the first coordinate system, using the variable that minimizes the loss function.

3. The system according to claim 2, wherein the circuity is configured to:
set a first variable satisfying a given condition for performing inverse stereographic projection into the second coordinate system,
calculate a second variable that minimizes the loss function using the coordinates of the mobile terminal, the coordinates of the mobile terminal being calculated using the first variable,
determine whether or not an absolute value of a difference between the first variable and the second variable is equal to or more than a given value,
when the absolute value is equal to or more than the given value,
reset the second variable to the first variable, and
calculate the coordinates in the second coordinate system using the reset first variable, the plurality of pieces of position information, and the plurality of pieces of time information, and
when the absolute value is less than the given value, convert the coordinates in the second coordinate system into the coordinates in the first coordinate system, using the second variable.

4. A method of identifying position information indicating a position of a mobile terminal, the method comprising:
obtaining a plurality of pieces of position information indicating positions of a plurality of communication devices, the plurality of communication devices being fixed at respective installation positions;
obtaining a plurality of pieces of time information, the plurality of pieces of time information including information on times of reception of a communication from the mobile terminal by the respective communication devices;
calculating, by circuitry, coordinates in a second coordinate system in which a projection surface is present using a variable, the plurality of pieces of position information, and the plurality of pieces of time information, the second coordinate system having higher dimensions than a first coordinate system indicating the plurality of pieces of position information and the plurality of pieces of time information, the variable being used for projection of the first coordinate system onto the projection surface that is defined in the second coordinate system and onto which projection may be performed without limitation in a time direction; and
identifying the position information by converting the calculated coordinates in the second coordinate system into coordinates in the first coordinate system.

5. The method according to claim 4, further comprising:
defining a loss function using the plurality of pieces of position information, the plurality of pieces of time information, and the output coordinates of the mobile terminal in the second coordinate system;
setting the variable that minimizes the loss function; and
converting the coordinates in the second coordinate system into the coordinates in the first coordinate system, using the variable that minimizes the loss function.

6. The method according to claim 5, further comprising:
setting a first variable satisfying a given condition for performing inverse stereographic projection into the second coordinate system;
calculating a second variable that minimizes the loss function using the coordinates of the mobile terminal, the coordinates of the mobile terminal being calculated using the first variable;
determining whether or not an absolute value of a difference between the best variable and the second variable is equal to or more than, a given value;
when the absolute value is equal to or more than the given value
resetting the second variable to the first variable, and
calculating the coordinates in the second coordinate system using the reset first variable, the plurality of pieces of position information, and the plurality of pieces of time information; and
when the absolute value is less than the given value, converting the coordinates in the second coordinate system into the coordinates in the first coordinate system, using the second variable.

7. A non-transitory storage medium storing a program that causes circuitry execute a process, the process comprising:
obtaining a plurality of pieces of position information indicating positions of a plurality of communication devices, the plurality of communication devices being fixed at respective installation positions;
obtaining a plurality of pieces of time information, the plurality of pieces of time information including information on times of reception of a communication from the mobile terminal by the respective communication devices;
calculating, by circuitry, coordinates in a second coordinate system in which a projection surface is present using a variable, the plurality of pieces of position information, and the plurality of pieces of time information, the second coordinate system having higher dimensions than a first coordinate system indicating the plurality of pieces of position information and the plurality of pieces of time information, the variable being used for projection of the first coordinate system onto the projection surface that is defined in the second coordinate system and onto which projection may be performed without limitation in a time direction; and
identifying the position information by converting the calculated coordinates in the second coordinate system into coordinates in the first coordinate system.

8. The storage medium according to claim 7, wherein the process further comprises:
defining a loss function using the plurality of pieces of position information, the plurality of pieces of time information, and the output coordinates of the mobile terminal in the second coordinate system;
setting the variable that minimizes the loss function; and
converting the coordinates in the second coordinate system into the coordinates in the first coordinate system, using the variable that minimizes the loss function.

9. The storage medium according to claim 8, wherein the process further comprises:
setting a first variable satisfying a given condition for performing inverse stereographic projection into the second coordinate system;
calculating a second variable that minimizes the loss function using the coordinates of the mobile terminal, the coordinates of the mobile terminal being calculated using the first variable;
determining whether or not an absolute value of a difference between the first variable and the second variable is equal to or more than a given value;
when the absolute value is equal to or more than the given value,
resetting the second variable to the first variable, and
calculating the coordinates in the second coordinate system using the reset first variable, the plurality of pieces of position information, and the plurality of pieces of time information; and
when the absolute value is less than the given value, converting the coordinates in the second coordinate system into the coordinates in the first coordinate system, using the second variable.
